(19) United States
(12) Patent Application Publication
(10) Pub. No.: US 2003/0225714 A1
(43) Pub. Date: Dec. 4, 2003

(54) Formulator

(76) Inventor: Peter Paul Martizano Catalasan, Harbor City, CA (US)

Correspondence Address: Peter Paul Catalasan, 25410 Dodge Ave #K, Harbor City, CA, 90710, US

(21) Appl. No.: 10/074,933

(22) Filed: May 16, 2002

(51) Int. Cl. G06F 17/00; G06N 5/02; G06F 15/18; G06G 7/00; G06N 3/02; G06E 3/00; G06E 1/00

(52) U.S. Cl. 706/16; 706/15; 706/46

(57) ABSTRACT

Historically, mathematicians and scientists have never really defined creativity, and more importantly, Mathematical Creativity. This Patent Application introduces the precise definition and system model of a new Artificial Intelligence paradigm that conforms to Strong AI claims with Artificial Neural Networks, called Logic Formulators. Not only does it encompass automated programming, but design as well, since the model creates a New Object from Two Old Distinct Mathematical Objects. Given this new opportunity to develop such a machine, I am attending the California State University Long Beach with the help of a favorite and talented professor, Dr Thinh Nguyen, and will finish my thesis entitled, “Mathematical Creativity through the Application of Chaotic-Logic Generators Between Two Distinct Mathematical Objects Using an Artificial Neural Network”

### I. INTRODUCTION—FIELD OF INVENTION

What is Creativity? How does a computer simulate or even obtain creativity, the Strong AI? Here, I claim that Creativity is Strong Al. Since by the Webster's New World Dictionary and Thesaurus, Creativity is defined to be “causing to come into being, make or originate, to bring about, to give rise to, or cause,” means that Creativity belongs to high level processes only available to programmers and designers; however, until now^{|} Making scratches on my scientific diary and playing tic-tac-toe, I stumbled upon the definition and process of Mathematical Creativity. Happily surprised, I continued to refine its System Model to actually and precisely define it to be, “Mathematical Creativity through the Application of Chaotic-Logic Generators between Two Distinct Mathematical Objects Using an Artificial Neural Network,” the Field of Artificial Intelligence.

### II. PRECISE DEFINITION OF MATHEMATICAL CREATIVITY—SUMMARY OF INVENTION

This Work is dedicated to Juliet, Kathleen Bonnell, who romantically died with Romeo, Peter Paul Catalasan at the age of Thirty-five. With God, True Love never dies! I would also like to thank my Professor, Thinh Nguyen, and Inventor of Love, for giving me the knowledge of Love and Laughter, how I really learned True Computer Science Curriculum.

This is not a Thesis about Complex Love or Compassion Situations, but, having personally discovered Mathematical Creativity, using the mathematical logic and computer science implementation techniques, I have made progress to create machines that formulate logic on its own, called, logic formulators; they are no longer computers but are the very next computer revolution. Discovering this new breakthrough in True Creative Machines, where these formulators actually generate new mathematical relationships independent of outside human intervention, develops a beginning point to the True Next Computer Revolution.

I will now explain my logic formulator with an easy example, Analytic Geometry. How did Descartes create Analytic Geometry, new mathematics at that time? Well, he started with Two Old Distinct Mathematical Objects, namely Algebra and Geometry. He compared and contrasted the Two Objects by dividing each object into separate Components and chaotically mixing and matching each component with each other, but creating a relationship or “logic connector” between each Component. For example, X²+Y²=R², has a mathematical-logical-relationship, MLR, to a Geometric Circle. Thus, producing Analytic Geometry!

The Implementation Details are a bit more complex due to the nature of Mathematics and Hardware of simple Boolean Logic. But you get the picture, right?

### III. BRIEF DESCRIPTION OF DRAWINGS

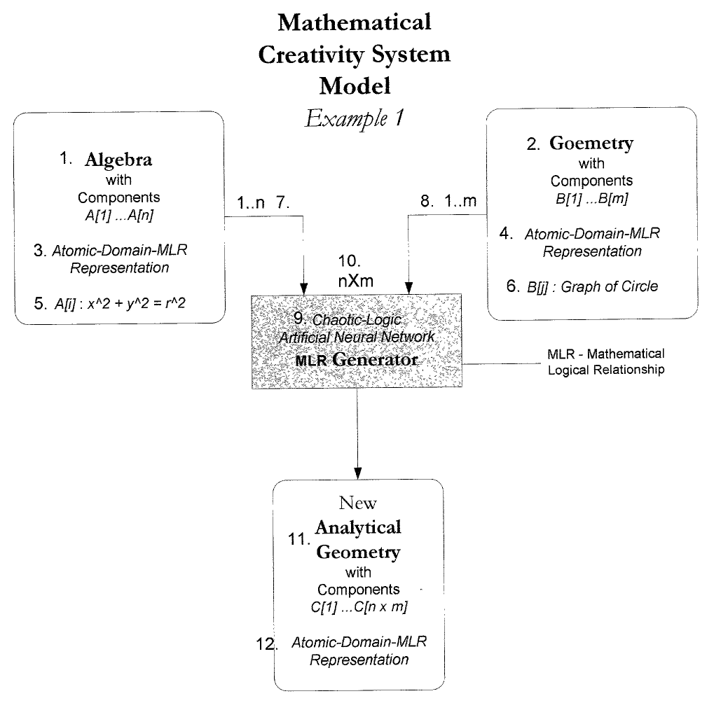

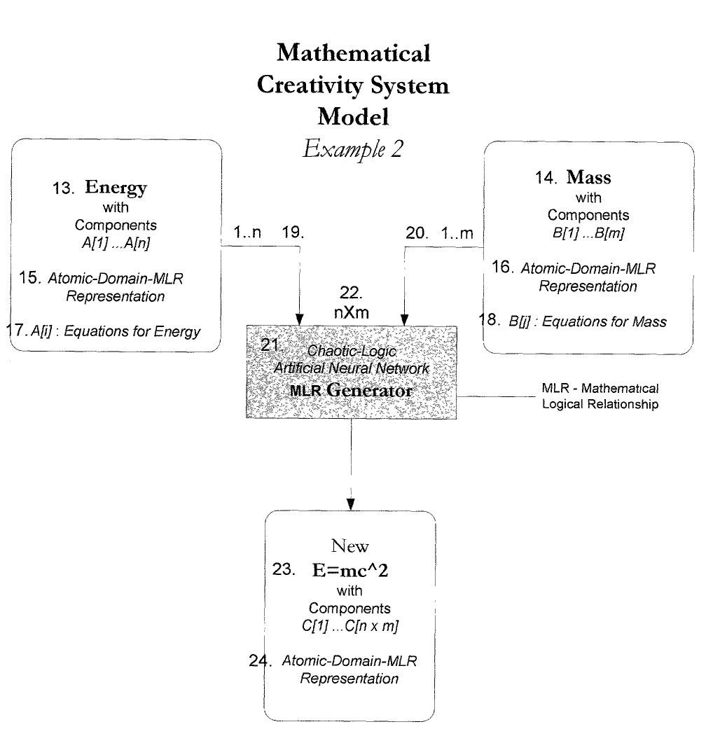

The Mathematical Creativity System Model—Example 1, on Drawing Pages, is an example of Generating New Mathematics. Algebra, FIG. 1, has independent components, A [I], such as x²+y², FIG. 5, represented using an Atomic-Domain-Mathematical Logical Relationship, FIG. 3. Similarly, Geometry, FIG. 2, has independent components, B [j] such as a Graph of a Circle, FIG. 6, represented using an Atomic-Domain-Mathematical Logical Relationship, FIG. 4. Take one component from 1 . . . n, FIG. 7, of Geometry and take one component from 1 . . . m, FIG. 8, of Algebra, creating a MLR or Mathematical Logical Relationship, FIG. 9, repeating this for all n×m, FIG. 10, produces New Mathematics, Analytic Geometry, FIG. 11, with components C [I] . . . C [n×m] represented in Atomic-Domain-MLR, FIG. 12.

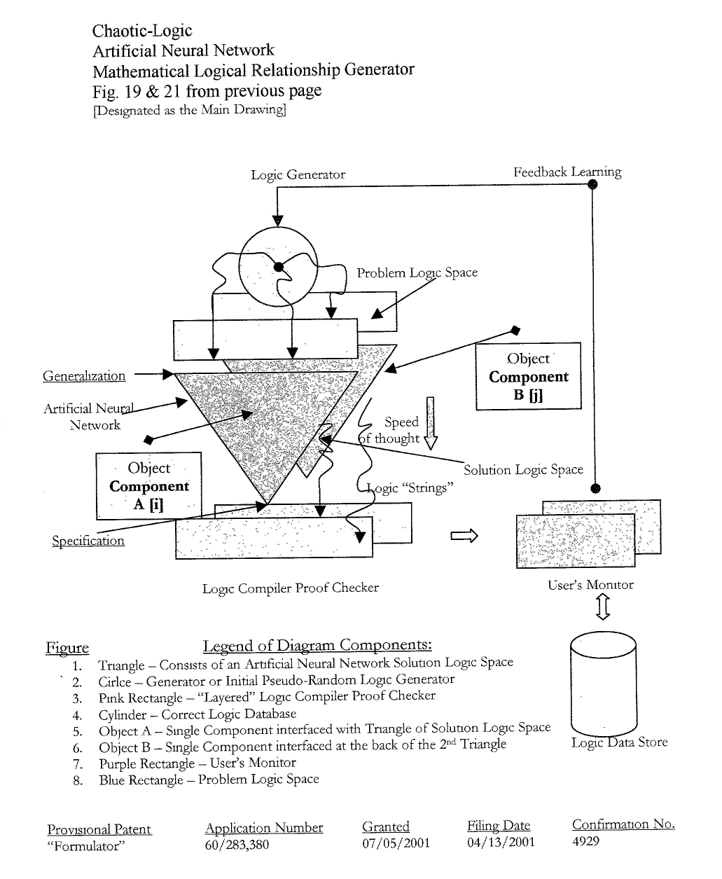

The Mathematical Creativity System Model—Example 2, on Drawing Pages, is an example of Finding and Simplifying New Mathematical Relationships. Energy, FIG. 13, has independent components, A [I], such as the Equations for Energy, FIG. 17, represented using an Atomic-Domain-Mathematical Logical Relationship, FIG. 15. Similarly, Mass, FIG. 2, has independent components, B [j] such as the Equations for Mass, FIG. 18, represented using an Atomic-Domain-Mathematical Logical Relationship, FIG. 16. Take one component from 1 . . . n, FIG. 19, of Energy and take one component from 1 . . . m, FIG. 20, of Mass, creating a MLR or Mathematical Logical Relationship, FIG. 21, simplifying this for all n×m, FIG. 22, produces a Simplified Object, E=mc², FIG. 23, with components C [I] . . . C [n×m] represented in Atomic-Domain-MLR, FIG. 24.

The Chaotic-Logic Artificial Neural Network MLR (Mathematical Logical Relationship) Generator is presented in Drawing Pages. The Legend of Diagram Components maps the component to FIGS. 1 . . . 8

This system has a Logic Generator, FIG. 2, that produces initial logic for use in passing through the Problem Logic Space, FIG. 8, and into the Solution Logic Space, FIG. 1, the most important feature uses an Artificial Neural Network to map an Object A component, FIG. 5, and Object B component, FIG. 6 Once it has established this, the Layered Logic Compiler proof checker, FIG. 3, passes the Correct Logic to the User's Monitor, FIG. 7, and into the Logic Database, FIG. 4, upon which the information is fed back to the Generator for Machine Learning.

### IV. DESCRIPTION OF PREFERRED EMBODIMENTS

The Mathematical Creativity System Model, Example 1, on Drawing Pages, consists of Two Mathematical Objects, Algebra, FIG. 1, and Geometry, FIG. 2, and a Chaotic-Logic Artificial Neural Network MLR Generator, FIG. 9, that produces a New Mathematical Object, inheriting the properties of the Two Old Mathematical Objects, to form Analytic Geometry, FIG. 11, and again in an Atomic-Domain-MLR Representation.

The Mathematical Object, Algebra, FIG. 1, has distinct components, A [1] . . . A [n] that is described in an Atomic-Domain-MLR Representation, FIG. 3, with an example for one component A [i]: x²+y²=r², FIG. 5, for some value i, n∈N.

The Mathematical Object, Geometry, FIG. 2, has distinct components, B [1] . . . B [m] that is described in an Atomic-Domain-MLR Representation, FIG. 4, with an example for one component B [j]: Graph of Circle, FIG. 5, for some value j, m∈N.

The Chaotic-Logic Artificial Neural Network MLR Generator, FIG. 9, generates a MLR, or Mathematical Logical Relationship, through the use of an Artificial Neural Network Schema shown on Drawing Pages. The MLR is a Logic “String” that becomes parsed by a Layered Logic Compiler, FIG. 3, on Drawing Pages, which converts it to a Simplified Equation or Algorithm.

The New Mathematical Object, Analytic Geometry, FIG. 11, has distinct components, C [1] . . . C [p] that is described in an Atomic-Domain-MLR Representation, FIG. 12, with an example for one component C [k]: Equation of Graph of Circle, for some value k, p∈N.

The Mathematical Creativity System Model, Example 2, on Drawing Pages, consists of Two Mathematical Objects, Energy, FIG. 13, and Mass, FIG. 14, and a Chaotic-Logic Artificial Neural Network MLR Generator, FIG. 21, which produces a New Mathematical Object, inheriting the properties of the Two Old Mathematical Objects, to form Equations of Energy and Mass, FIG. 23, and again in an Atomic-Domain-MLR Representation.

The Mathematical Object, Energy, FIG. 13, has distinct components, A [1] . . . A [n] that is described in an Atomic-Domain-MLR Representation, FIG. 15, with an example for one component A [i]: Equation for Energy, FIG. 17, for some value i, n∈N.

The Mathematical Object, Mass, FIG. 14, has distinct components, B [1] . . . B [m] that is described in an Atomic-Domain-MLR Representation, FIG. 16, with an example for one component B [j]: Equation for Mass, FIG. 18, for some value j, m∈N.

The Chaotic-Logic Artificial Neural Network MLR Generator, FIG. 21, generates a MLR, or Mathematical Logical Relationship, through the use of an Artificial Neural Network Schema shown on Drawing Pages. The MLR is a Logic “String” that becomes parsed by a Layered Logic Compiler, FIG. 3, on Drawing Pages, which converts it to a Simplified Equation or Algorithm.

The New Mathematical Object, Energy and Mass, FIG. 23, has distinct components, C [1] . . . C [p] that is described in an Atomic-Domain-MLR Representation, FIG. 24, with an example for one component C [k]: Equation of Energy and Mass, E=mc², for some value k, p∈N

The Chaotic-Logic Artificial Neural Network Mathematical Logical Relationship, MLR, Generator, FIGS. 19 & 21, from Drawing Pages, and described in more detail from Drawing Pages, consists of the Logic Generator, FIG. 2, Problem Logic Space, FIG. 8, Artificial Neural Network, FIG. 1, Layered Logic Compiler Proof Checker, FIG. 3, User's Monitor, FIG. 7, Logic Data Store, FIG. 4, and Feedback Learning.

The Logic Generator, FIG. 2, from a pseudo-random seed, creates an initial-logic string to accommodate future logic “attachments, and modifications,” when the logic string passes through the Problem Logic Space and Artificial Neural Network Systems.

The Problem Logic Space, FIG. 8, is the next entrance after the Logic Generator. Then, the Logic “String” passes through one pathway of creating the problem to be solved.

The next, and the most complicated, Artificial Neural Network, FIG. 1, takes the Logic “String” from the Problem Space and begins to transform, given its problem information, into a Solution Logic “String.”

The Layered Logic Compiler Proof Checker, FIG. 3, then, analyzes the Solution Logic “String” through a Layered Logic Compiler. If correct it sends the Logic Answer “String” to the User's Monitor, FIG. 7, and Database Logic Storage, FIG. 4.

The User's Monitor, FIG. 7, is where one can control the events of this system, write a structured requirements definition, and provide design manipulation.

The Logic Data Store, FIG. 4, is storage for Correct Logic provided by the Layered Logic Compiler Proof Checker and User Information.

The Feedback Learning, from the User 's Monitor to the Logic Generator, provides the capability of controlling Logic “Strings” and for Machine Learning.

The Conversion of the Logic “Strings” into an Algorithm provides the capability of automated programming through Mathematical Logical Relationship Generation and Conversion into a programming language.

The Total Conglomeration of this System, since I have only specified One Component A [i], of an Object to be mapped to One Component, B [j], of an Object, there must be a simultaneous mapping of All Components through the use of Parallel Architectures and Multiprocessors

More importantly, is this System's Ability to Design as well, since it can create a New Object from Two Old Distinct Objects. However, in order to Design, this System requires the appropriate injection and initial input of Objects, which is quite similar to Human Learning and Design.

### ACRL™

### Advanced Catalasan Research Laboratories, Inc

This Work is dedicated to my Most Intelligent Brother, Manolito Catalasan, who invited Peter Paul Catalasan to study Physics at the University of California at Riverside, upon which Peter Paul became the first to discover Unlimited Energy through Matter/Antimatter Production/Separation.

Having the knowledge of Unlimited Energy, we can apply such energies to overcome long distances through the use of Einstein's properties of Relativity upon which many equations have negative time dependency related to the speed of light. For example, if it takes one million light-years to get to another Galaxy, why not go back in time for one million light-years while traveling there, therefore arriving at t=0.

Given this opportunity, and a coordinated research effort between Valentino Catalasan, Victor Catalasan, and Peter Paul Catalasan, we can form an Advanced Research Laboratory, called the Advanced Catalasan Research Laboratory, Inc, or ACRL, which will spin off to a committed effort for any Noble Research Activity, where Manolito, as Chief Executive Officer, will own the Research Information. The responsibilities of research and development come from Valentino Catalasan—Chief Technology Officer, Peter Paul Catalasan—Research Director, and Victor Catalasan—Engineering Physicist. We all have Technological First Loves, Computer Science for Valentino, Physics for Peter Paul, Engineering for Victor, and the Last Star Fighter Austin Catalasan.

1. Formulator Current claims are as follows:
1. New Mathematics Generation
2. Automated Design of any Application
3. Automated Programming
4. Automated Research of any Application
5. Robotic & Artificial Intelligence Evolution by Feedback Design
